(19) United States
(12) Patent Application Publication
(10) Pub. No.: US 2014/0333669 A1
(43) Pub. Date: Nov. 13, 2014

(54) SYSTEM, METHOD, AND COMPUTER PROGRAM PRODUCT FOR IMPLEMENTING SMOOTH USER INTERFACE ANIMATION USING MOTION BLUR

(71) Applicant: NVIDIA CORPORATION, Santa Clara, CA (US)

(72) Inventor: Martin Stich, Berlin (DE)

(73) Assignee: NVIDIA Corporation, Santa Clara, CA (US)

(21) Appl. No.: 13/890,186

(22) Filed: May 8, 2013

(51) Int. Cl. G06T 11/60

(52) U.S. Cl. CPC G06T 11/60
USPC 345/634

(57) ABSTRACT

A system, method, and computer program product for applying a motion blur filter to image data representing a graphical user interface is disclosed. The method includes the steps of generating image data representing a graphical user interface and applying a motion blur filter to at least a portion of the image data in one embodiment, the motion blur filter is applied to the image data by associating one or more motion vectors with the image data, and filtering a plurality of pixels in the image data based on the motion vectors.

### FIELD OF THE INVENTION

The present invention relates to computer graphics, and more particularly to computer-rendered animations.

### BACKGROUND

Conventional cameras capture objects in motion across a plurality of physical locations during an exposure. The shutter is opened for a length of time known as the exposure period. As an object moves from one point to another during the exposure period, the object will be elongated in the direction of motion. The result is that fast moving objects appear as streaks in the resulting image, slow moving objects appear slightly blurry and elongated, and stationary objects appear sharp and in-focus. Photographers can adjust the amount of motion blur by increasing the exposure time and decreasing the aperture size.

Computer-rendered images typically do not account for varying exposure times, aperture sizes, and the like. Typically, rays are intersected with objects in a scene and the surface colors of intersected objects are used to generate the colors of pixels in a computer-generated image. More recently, some high-end rendering systems have implemented a motion blur filter when rendering computer-generated animation for movies. For example, Pixar's RenderMan™ software allows a user to explicitly add motion blur to rendered scenes. However, this software is complex and only used for high-end computer-rendered graphics, commonly taking many seconds to minutes to render a single frame.

User interfaces typically implement simple two-dimensional menus using text and/or images. The user interface may be a graphical user interface that includes icons, background images, and the like, such as with the Microsoft™ Windows or the Apple™ iOS graphical user interfaces. Very few components of a conventional graphical user interface are animated. For example, a cursor may be animated or a window may be opened that shows a status bar that changes as a task is executed, but animation is not a large part of conventional graphical user interfaces. Consequently, rendering pipelines for generating pixels for display that represent the graphical user interface do not include complex algorithms for making object motion appear realistic. Animations are typically effectuated by refreshing the graphical user interface at a high refresh rate (e.g., 60 Hz) such that static images are changed rapidly. However, the computer-generated graphics typically appear sharp and in-focus for each particular frame that is displayed, causing the user to perceive the animation to be jumpy. This effect may be displeasing to a user. Thus, there is a need for addressing this issue and/or other issues associated with the prior art.

### SUMMARY

A system, method, and computer program product for applying a motion blur filter to image data representing a graphical user interface is disclosed. The method includes the steps of generating image data representing a graphical user interface and applying a motion blur filter to at least a portion of the image data in one embodiment, the motion blur filter is applied to the image data by associating one or more motion vectors with the image data, and filtering a plurality of pixels in the image data based on the motion vectors.

### BRIEF DESCRIPTION OF THE DRAWINGS

FIG. 1 illustrates a flowchart of a method for applying a motion blur filter to image data representing a graphical user interface, in accordance with one embodiment;

FIG. 2 illustrates a graphical user interface, in accordance with one embodiment;

FIG. 3 illustrates an animation generated by an operating system as a part of the graphical user interface of FIG. 2, in accordance with one embodiment;

FIG. 4 illustrates a system configured to generate image data for a graphical user interface, in accordance with one embodiment;

FIG. 5 illustrates a flowchart of a method for applying a motion blur filter to image data representing a graphical user interface, in accordance with another embodiment; and

FIG. 6 illustrates an exemplary system in which the various architecture and/or functionality of the various previous embodiments may be implemented.

### DETAILED DESCRIPTION

A technique for generating smoother animations in a graphical user interface is described below. A user interface may generate animations by rendering objects in multiple frames and then applying a motion blur filter to portions of each frame. A rendering pipeline is configured to add a motion blur effect to the objects based on a magnitude of a motion vector associated with each object. The motion blur filter can be applied, e.g., when a user drags an icon across a desktop (i.e., in response to user input such as input generated by a mouse) or applied automatically when an animation is launched by the graphical user interface.

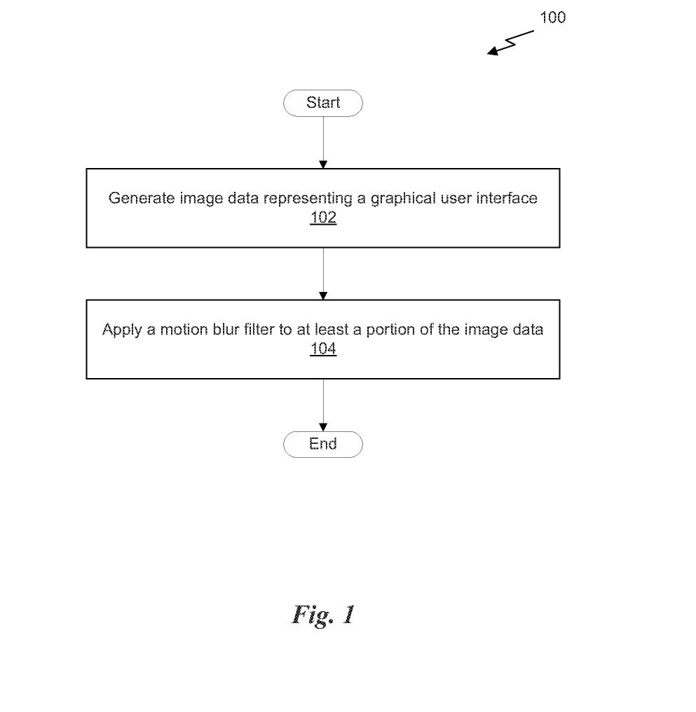

FIG. 1 illustrates a flowchart of a method 100 for applying a motion blur filter to image data representing a graphical user interface, in accordance with one embodiment. At step 102, image data representing a graphical user interface is generated for display. In one embodiment, the graphical user interface includes one or more surfaces representing computer-rendered objects for display on a display device. The objects may be icons, components of an application such as button or text objects, graphical objects such as bitmap images, and the like. At step 104, a motion blur filter is applied to at least a portion of the image data. For example, a motion blur filter may be applied to a plurality of pixels in the image data associated with an object moved between a first location and a second location in screen space between a first frame of image data and a second frame of image data. In one embodiment, the motion blur filter may be applied to any pixels between the first location for the object and the second location of the object.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

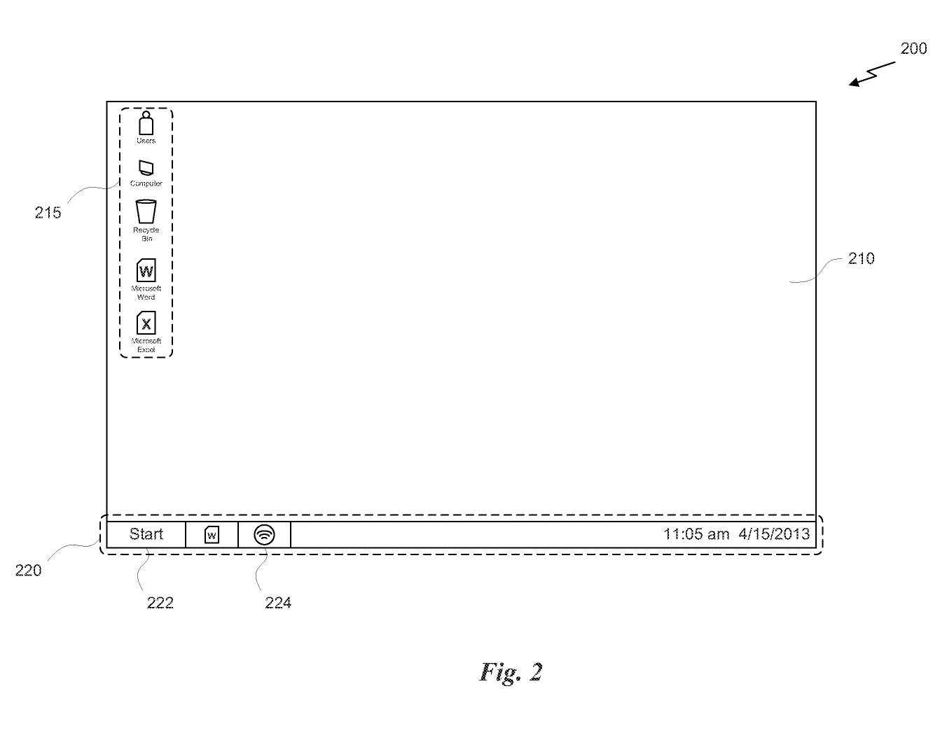

FIG. 2 illustrates a graphical user interface 200, in accordance with one embodiment. As shown in FIG. 2, the graphical user interface (GUI) 200 comprises a desktop surface 210 that includes a plurality of icons 215 associated with applications and/or data (e.g., documents, spreadsheets, etc.). The background of the desktop surface may display an image or a background color. The GUI 200 may also include a taskbar 220. In one embodiment, the taskbar 220 includes a start menu 222 from which one or more applications may be launched. When applications are running in the background, a taskbar button 224 may be displayed within the taskbar 220 that can be used to activate the window for a particular application. Although not shown explicitly, the taskbar 220 may also include a quick launch menu that displays a subset of icons that enable a user to quickly access and launch an application which may or may not be associated with a separate icon of the plurality of icons 215 on the desktop surface 210.

It will be appreciated that the GUI 200 is similar to a GUI implemented by various version of Microsoft™ Windows. However, the present disclosure is not intended to be limited to the conventional desktop environment of a desktop operating system such as Microsoft™ Windows, Apple™ OSX, or various distributions of the Linux™ operating system that implement a desktop environment (e.g., KDE, GNOME, Xfce, Cinnamon, etc.). The optional architectures within which the aforementioned framework may be implemented may also include mobile devices using the Apple™ iOS and Google™ Android operating systems. Yet additional architectures are also contemplated as being within the scope of the present disclosure. For example, graphical user interfaces implemented on gaming consoles such as the Nintendo™ Wii, Sony™ Playstation, and others. In other words, the aforementioned framework may be implemented on any architecture configured to generate a graphical user interface for display on a display device.

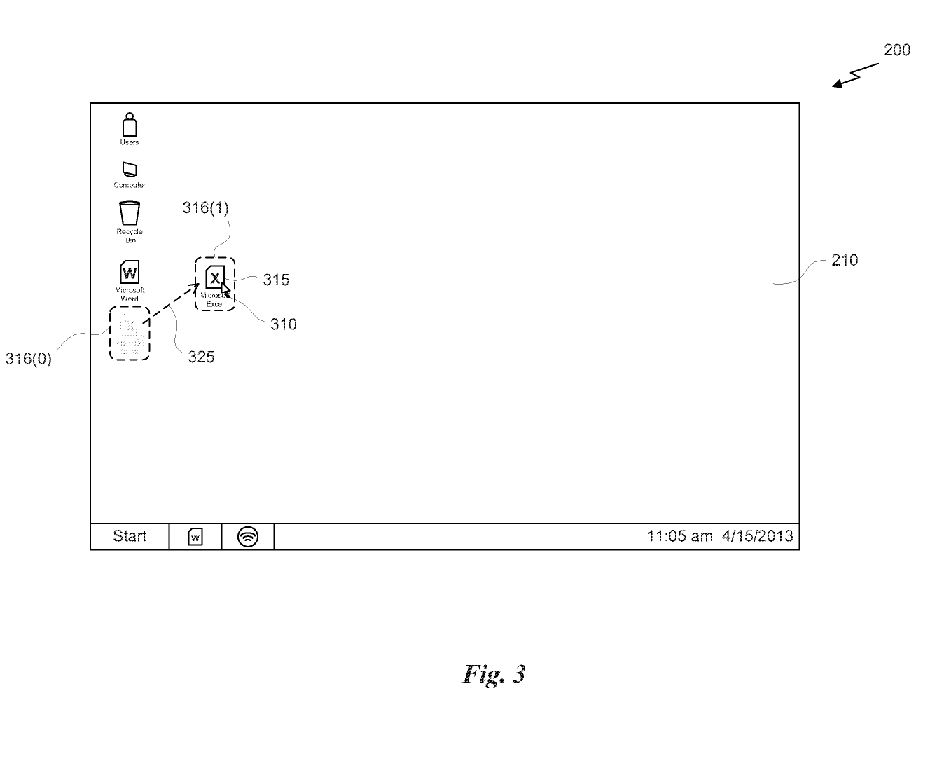

FIG. 3 illustrates an animation generated by an operating system as a part of the GUI 200 of FIG. 2, in accordance with one embodiment. As shown in FIG. 3, the operating system may enable a user to select an icon 315 of the plurality of icons 215 with a mouse device and move that icon 315 to another location on the desktop surface 210. For example, a user may place a mouse cursor 310 over the icon 315, depress a mouse button, and drag the mouse cursor 310 and icon 215 to a new location on the desktop surface 210. As shown in FIG. 3, a user may have dragged the icon 315 from a first location 316(0) to a second location 316(1) on the desktop surface 210. The difference between the first location 316(0) and the second location 316(1) is given by a motion vector 325. The motion vector 325 reflects the difference between a pixel location within the object at the first location 316(0) and a corresponding pixel location within the object at the second location 316(1). An animation is generated to represent the user moving the mouse device and dragging the icon 315 to the second location 316(1). As used herein, an animation refers to two or more consecutive frames of image data that show a representation of an object in two separate and distinct locations relative to the screen-coordinates of a display device.

Conventionally, an operating system would not generate the animation of the moving icon 315 using any sort of motion blur filter. In other words, for a first frame of video, the operating system would generate an image having a representation of the icon 315 displayed at the first location 316(0), and then, for a second frame of video, the operating system would generate an image having a representation of the icon 315 displayed at the second location 316(1). Inspecting each frame of video separately, a user could not tell whether the icon 315 was stationary or in motion because the icon 315 is rendered without any type of motion blur filter. At a frame rate of 30 frames per second, the perceived animation can appear to be jumpy, which is unpleasing to the eye. Some systems may attempt to solve this issue by speeding up the frame rate of the rendered GUI 200. However, speeding up the frame rate requires the rendering for each frame to be performed in less time, thereby limiting the complexity of the scene and, potentially, limiting the resolution of the displayed image. In addition, increasing the frame rate does not solve the issue of animations appearing jumpy, but merely attempts to lessen the effects perceived by a user. Thus, increasing the frame rate is not an ideal solution to this issue.

In one embodiment, the operating system implements a GUI 200 that includes a motion blur filter when displaying animations. In the case of dragging an icon 315 across the desktop, for example, an image processing pipeline may add a motion blur filter to representations of the icon 315. The motion blur filter may be applied using temporal anti-aliasing techniques such as by generating a plurality of frames at different times, displacing the moving object by a portion of the total motion vector 325 within each intermediate frame, and then blending the plurality of intermediate frames to produce a composite frame. In another embodiment, the motion blur filter may be applied by filtering each frame based on a previous frame and generating filtered pixels by sampling a plurality of pixels within the frame along an direction parallel to the motion vector 325. In yet other embodiments, more complex motion blur filtering techniques may be applied, such as applying a motion blur filter along a curved path, or applying a motion blur filter based on a non-linear speed adjustment along the motion vector 325.

In one embodiment, the motion blur filter generates filtered values for a plurality of pixels associated with a moving object. The plurality of pixels may be any pixels that overlap rays between each pixel of the object in a first frame and each corresponding pixel of the object in a second frame. For each pixel in the plurality of pixels, a new pixel value is by sampling a number of pixels adjacent to the pixel in the direction of the motion vector and combining the sampled pixel values to generate a filtered value for the pixel. The number of pixels sampled may be based on the magnitude of the motion vector (i.e., small magnitudes filter values from a smaller number of adjacent pixels and large magnitudes filter values from a larger number of adjacent pixels).

It will be appreciated that the motion blur filter is not limited to only being applied to animations involving an icon 315. A motion blur filter may be applied to other types of animations implemented as a part of the GUI 200 such as animations that show a user flipping through pages on a home screen (e.g., in Apple iOS), scrolling through content displayed as part of an application (e.g., scrolling down a webpage), zooming into and out of content, flipping through collections of items, transitions between different components of an application (e.g., pages of an application), or any type of object movement (e.g., rotation, scaling, transformation, appearance or disappearance of objects such as icons, text fields, images, etc.). The preceding list is provided for illustration only and is not intended to be limiting in any manner.

In one embodiment, a motion blur filter may be applied to each surface implemented as a part of the GUI 200. Again, a surface is a data structure stored in a memory that represents a digital image to be displayed on the display device. Multiple surfaces may be combined to produce a final composite image for display. In other words, each surface may represent a different layer, or depth, within a stack of different surfaces that are combined or blended to generate the final image for display. For example, the desktop surface 210 and taskbar 220 may comprise a first surface rendered by the operating system. In addition, one or more applications may be associated with active windows that are represented by other surfaces. The other surfaces are overlaid on the desktop surface 210.

In one embodiment, a motion blur filter may be applied to each surface separately and then the filtered surfaces may be combined to generate a composite image for display. In another embodiment, each of the surfaces may be combined to generate a composite image and then a motion blur filter may be applied to the composite image to generate a modified composite image for display. In yet another embodiment, the motion blur filter may be applied to each object in a particular surface to generate a plurality of modified pixels within the surface corresponding to a motion vector associated with each object. In other words, different motion vectors may be calculated for each object included in a surface, a motion blur filter is applied to a plurality of pixels within the surface that are associated with each particular object based on the corresponding motion vector, and then the modified surface is combined with one or more other surfaces, modified using the motion blur filter or not, to generate the composite image for display. In still other embodiments, a motion vector field may be generated for a surface or a composite image, where each pixel in the surface or composite image is associated with a motion vector that reflects a difference in position for the pixel in two consecutive frames. The motion blur filter may then be applied to each pixel in the surface or image based on the motion vector field.

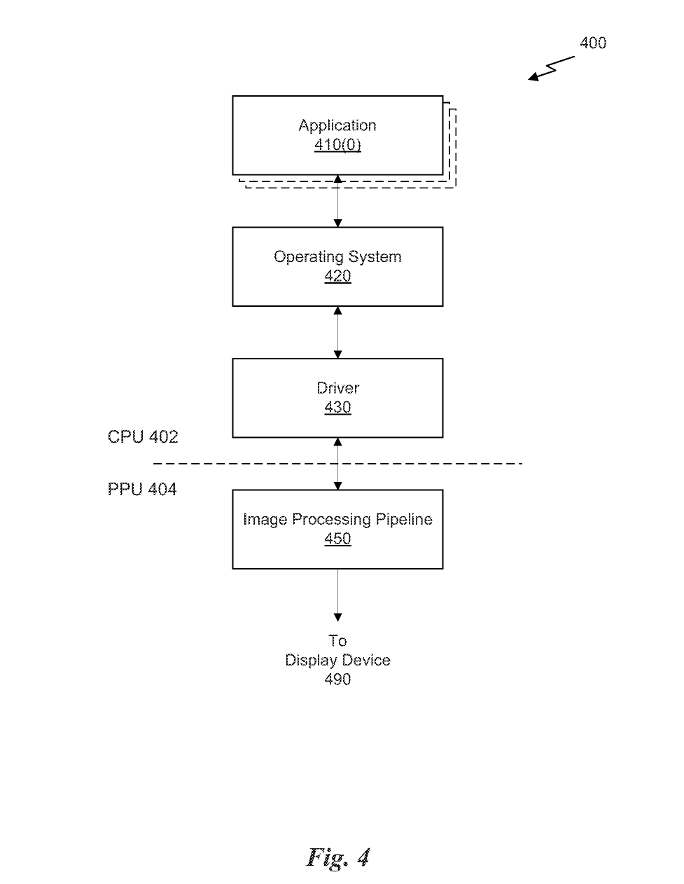

FIG. 4 illustrates a system 400 configured to generate image data for a graphical user interface, in accordance with one embodiment. The system 400 includes a central processing unit (CPU) 402, a parallel processing unit (PPU) 404 and a memory (not explicitly shown). The memory stores one or more applications 410 as well as an operating system 420 and a device driver 430. The device driver 430 implements an application programming interface (API), such as OpenGL or Direct3D, which enables the one or more applications 410 to take advantage of the processing capabilities of the PPU 404. The applications 410, operating system 420, and driver 430 are executed on the CPU 402. The operating system 420 enables certain capabilities such as multi-threading, scheduling, inter-process communication, and the like to be implemented by the system 400. The operating system 420 may also implement a graphical user interface that is configured to be displayed by the display device 490. The operating system 420, as well as one or more applications 410, may cause various surfaces to be generated in the memory that are combined into a composite image to be displayed by the display device 490. For example, the operating system 420 may cause a surface associated with the desktop surface 210 and taskbar 220 to be rendered and stored in the memory. An application 410 may generate another surface associated with an active window corresponding to a particular instance of the application 410 to be rendered and stored in the memory. The various surfaces may then be combined to generate a composite image for display.

The operating system 420 as well as each of the one or more applications 410 may make API method calls that are passed to the device driver 430. The API calls are interpreted by the driver 430, which generates commands and data that configure the image processing pipeline 450 to generate image data associated with the surfaces stored in the memory. The image processing pipeline 450 may be implemented by one or more programmable streaming multi-processors within the PPU 404. In one embodiment, the image processing pipeline 450 includes a vertex shader, a rasterizer, and a fragment shader. The vertex shader is configured to transform vertex data from one or more graphics primitives to generate transformed vertex data. The rasterizer is configured to map transformed vertex data in a three-dimensional space (e.g., world space, model space, etc.) to pixel data in a two-dimensional screen space. The fragment shader is configured to transform the pixel data to generate shaded pixel data. For example, the fragment shader may sample texture maps to generate a color value for a pixel. In one embodiment, the image processing pipeline 450 may implement a post-processing blending stage that is configured to apply the motion blur filter to at least a portion of the image data generated by the fragment shader.

In one embodiment, the system 400 does not include a PPU 404 and the image processing pipeline 450 may be executed by the CPU 402. For example, the image processing pipeline 450 may be implemented as another application 410 executed on the CPU 402. In other words, the system 400 may be implemented by a processor configured to generate image data representing a user interface, where the image data has a motion blur filter applied thereto, either by the same processor or by a co-processor coupled to the processor.

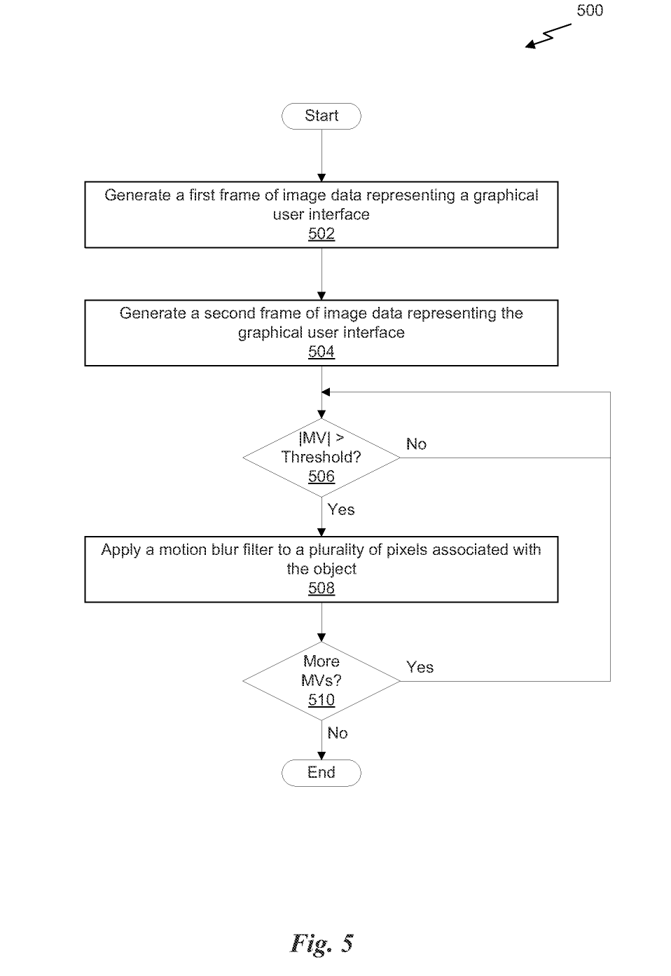

FIG. 5 illustrates a flowchart of a method 500 for applying a motion blur filter to image data representing a graphical user interface, in accordance with another embodiment. At step 502, an operating system 420 causes a first frame of image data representing a GUI 200 to be generated by the PPU 404. At step 504, the operating system 420 causes a second frame of image data representing the GUI 200 to be generated by the PPU 404. One or more representations of objects may be located at different screen-coordinates in the second frame of image data when compared to the first frame of image data. The image processing pipeline 450 may associate motion vectors with any object that has changed locations from the first frame to the second frame. Alternatively, the image processing pipeline 450 may associate a motion vector with each portion of the second frame of image data. Each portion may be a single pixel or multiple pixels. The motion vector 325 specifies a direction and magnitude (in pixels) that reflects the difference in location for corresponding objects between an original location of the object in the first frame of image data and a new location of the object in the second frame of image data.

For each motion vector associated with the second frame of image data, at step 506, the image processing pipeline 450 compares the magnitude of the motion vector 325 to a threshold value. If the magnitude of the motion vector 325 is less than or equal to the threshold value, then the motion blur filter is not applied to the second frame of image data based on the motion of the object. However, if the magnitude of the motion vector 325 is greater than the threshold value, then, at step 508, the image processing pipeline 450 applies a motion blur filter to a plurality of pixels in the second frame of image data that are associated with the object. In one embodiment, the image processing pipeline 450 applies the motion blur filter to any pixels overlapped by a ray from a particular pixel in the object in the first frame of image data to a corresponding pixel in the object in the second frame of image data. The ray corresponds to the motion vector 325 for the object. In one embodiment, for each pixel overlapped by the ray, a new pixel value may be generated by sampling a number of pixels in the direction of the ray and combining the sampled values to generate a new value for the pixel. At step 510, the image processing pipeline 450 determines whether there are more motion vectors 325 associated with the second frame of image data to process, and, if so, the method returns to step 506 where the additional motion vectors 325 are processed. However, if all of the motion vectors 325 associated with the second frame of image data have been processed, then the method 500 terminates and the filtered second frame of image data is transmitted to the display device 490 for display.

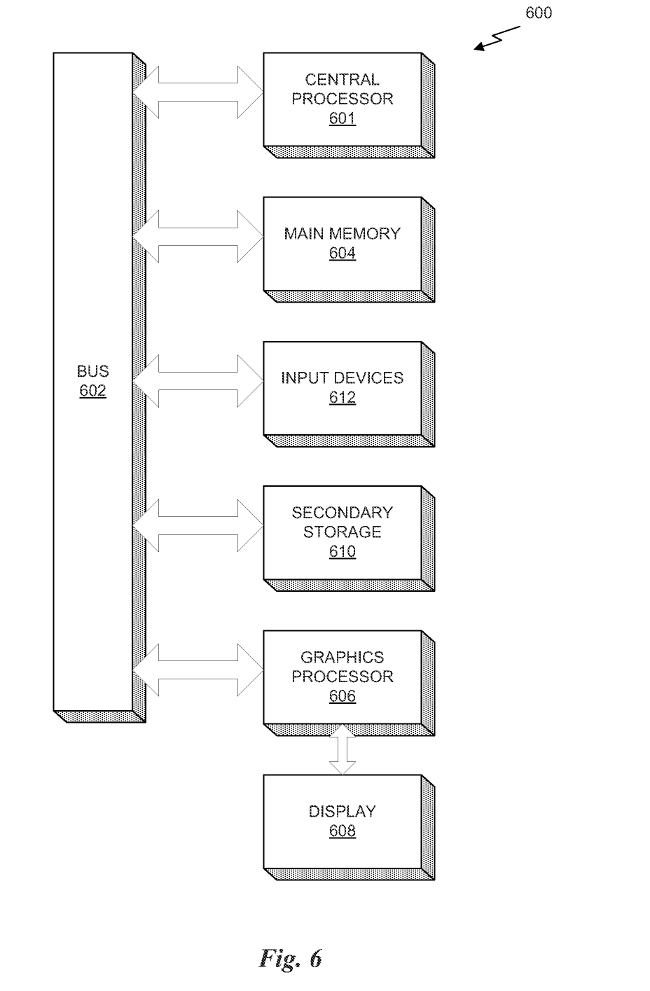

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM).

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. that are implemented as circuitry. Each of the foregoing modules may even be situated on a single semiconductor platform to form a graphics processing unit (GPU). In one embodiment, the graphics processor 606 may implement one or more PPUs 404.

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
generating image data representing a graphical user interface; and
applying a motion blur filter to at least a portion of the image data.

2. The method of claim 1, wherein the motion blur filter is applied to the image data by:
associating one or more motion vectors with the image data; and
filtering a plurality of pixels in the image data based on the motion vectors.

3. The method of claim 2, wherein the plurality of filtered pixels comprises a number of pixels in the image data overlaid by one or more motion vectors.

4. The method of claim 3, wherein a new value is generated for each pixel in the plurality of filtered pixels by sampling a number of pixels adjacent to the pixel in the direction of the motion vector and combining the sampled pixel values to generate a filtered value for the pixel.

5. The method of claim 2, wherein the filtering is performed if a magnitude of the motion vector is greater than a threshold value.

6. The method of claim 1, wherein the graphical user interface comprises a desktop environment.

7. The method of claim 6, wherein the motion blur filter is applied to one or more icons included in the desktop environment that are moved relative to screen-space coordinates associated with a surface of the desktop environment.

8. The method of claim 6, wherein the motion blur filter is applied to a surface that represents an application window in the desktop environment.

9. The method of claim 6, wherein the motion blur filter is applied to a composite image comprising combined pixel data from two or more surfaces in the desktop environment.

10. The method of claim 1, wherein the motion blur filter is included in an image processing pipeline comprising:
a vertex shader that is configured to transform vertex data associated with one or more graphics primitives;
a rasterizer that is configured to map transformed vertex data in three-dimensional space to pixel data in two-dimensional screen-space; and
a fragment shader that is configured to transform the pixel data.

11. The method of claim 10, wherein the image processing pipeline is implement d on a parallel processing unit.

12. The method of claim 10, wherein the motion blur filter is implemented within a blending stage of the image processing pipeline that follows the fragment shader.

13. The method of claim 1, further comprising transmitting the filtered image data to a display device for display.

14. A non-transitory computer-readable storage medium storing instructions that, when executed by a processor, cause the processor to perform steps comprising:
generating image data representing a graphical user interface; and
applying a motion blur filter to at least a portion of the image data.

15. The non-transitory computer-readable storage medium of claim 14, wherein the motion blur filter is applied to the image data by:
associating one or more motion vectors with the image data; and
filtering a plurality of pixels in the image data based on the motion vectors.

16. A system, comprising:
a memory; and
a processor coupled to the memory and configured to:
generate image data representing a graphical user interface, and
apply a motion blur filter to at least a portion of the image data.

17. The system of claim 16, wherein the processor is further configured to apply the motion blur filter to the image data by:
associating one or more motion vectors with the image data; and
filtering a plurality of pixels in the image data based on the motion vectors.

18. The system of claim 16, wherein the processor comprises a parallel processing unit.

19. The system of claim 18, wherein the parallel processing unit implements an image processing pipeline comprising:
a vertex shader that is configured to transform vertex data associated with one or more graphics primitives;
a rasterizer that is configured to map transformed vertex data in three-dimensional space to pixel data in two-dimensional screen-space; and
a fragment shader that is configured to transform the pixel data.

20. The system of claim 16, further comprising a central processing unit coupled to the processor.
